(19) United States
(12) Patent Application Publication
(10) Pub. No.: US 2015/0027871 A1
(43) Pub. Date: Jan. 29, 2015

(54) Catalyst Compositions Comprising In Situ Grown Zeolites on Clay Matrixes Exhibiting Hierarchical Pore Structures

(71) Applicant: KiOR, Inc., Pasadena, TX (US)

(72) Inventors: Dennis Stamires, Dana Point, CA (US); Michael Brady, Studio City, CA (US)

(21) Appl. No.: 14/378,749

(22) PCT Filed: Feb. 15, 2013
(86) PCT No.: PCT/US13/26293

§ 371 Date: Aug. 14, 2014

Related U.S. Application Data
(60) Provisional application No. 61/600,148, filed on Feb. 17, 2012.

(51) Int. Cl. B01J 29/40; C10L 1/00; C10G 1/00; C10B 53/02; B01J 21/16

(52) U.S. Cl. CPC B01J 29/40; C10B 53/02; B01J 21/16; C10G 1/002; C10L 1/00; B01J 2029/062
USPC 201/2.5; 502/80; 502/68; 585/240; 585/242

(57) ABSTRACT

A process for making a catalytic system for converting solid biomass into fuel of specialty chemical products is disclosed. The process includes preparing a slurry precursor mixture by mixing an aluminosilicate clay material with a pore regulating agent and optionally a binder, shaping the mixture into shaped bodies; removing the pore regulating agent to form porous shaped bodies, preparing an aqueous reaction mixture comprising the porous shaped bodies in presence of a zeolite seeding material, and thermally treating the aqueous reaction mixture to form the catalyst system. The catalyst system can comprise, for example, a MFI-type zeolite.

### RELATED APPLICATIONS

This application claims the benefit of and priority to U.S. provisional application Ser. No. 61/600,148, filed Feb. 17, 2012, the content of the foregoing application is hereby incorporated by reference in its entirety.

### FIELD OF THE INVENTION

The invention relates to catalyst compositions comprising in-situ grown zeolites into clay matrixes exhibiting hierarchical pore structures, and more particularly to catalyst compositions for use in the catalytic thermoconversion of solid biomass material into liquid fuels or specialty chemicals.

### BACKGROUND OF THE INVENTION

Biomass, in particular biomass of plant origin, is recognized as an abundant potential source of fuels and specialty chemicals. See, for example, “Energy production from biomass,” by P. McKendry—Bioresource Technology 83 (2002) p 37-46 and “Coordinated development of leading biomass pretreatment technologies” by Wyman et al., Bioresource Technology 96 (2005) 1959-1966. Refined biomass feedstock, such as vegetable oils, starches, and sugars, can be substantially converted to liquid fuels including biodiesel (e.g., methyl or ethyl esters of fatty acids) and ethanol. However, using refined biomass feedstock for fuels and specialty chemicals can divert food sources from animal and human consumption, raising financial and ethical issues.

Alternatively, inedible biomass can be used to produce liquid fuels and specialty chemicals. Examples of inedible biomass include agricultural waste (such as bagasse, straw, corn stover, corn husks, and the like) and specifically grown energy crops (like switch grass and saw grass). Other examples include trees, forestry waste, such as wood chips and saw dust from logging operations, or waste from paper and/or paper mills. In addition, aquacultural sources of biomass, such as algae, are also potential feedstocks for producing fuels and chemicals.

There is a need to develop cost-effective processes for the thermoconversion of biomass, and in particular to develop cost-effective catalyst compositions for use in the thermoconversion of biomass, or for the upgrading of bio-oils.

### SUMMARY OF THE INVENTION

Aspects of the invention relate catalyst compositions and methods of making catalyst composition for use in the thermoconversion of biomass, or for the upgrading of bio-oils. In some aspects of the invention, the method of making a biomass catalytic cracking catalyst system comprise the steps of (a) preparing a slurry precursor mixture by mixing an aluminosilicate clay material with a pore regulating agent and optionally a binder material, (b) shaping the mixture into shaped bodies, (c) removing the pore regulating agent to form porous shaped bodies, (d) preparing an aqueous reaction mixture comprising the porous shaped bodies in presence of a seeding material, (e) thermally treating the aqueous reaction mixture to form the catalyst system, and (f) contacting the catalyst system with biomass particles. In some embodiments, the catalyst system is mixed with biomass derived oils or biomass derived vapors.

In some embodiments, the pore regulating agent is an organic material selected from the group consisting of compounds containing cellulosic type, starch, sawdust, corn flour, wood flour, shortgum, gums, corn stover, sugar bagasse, plastic, resin, rubber, carbohydrates, organic polymers or mixtures thereof. In other embodiments, the pore regulating agent is an inorganic material selected from the group of saponite, halloysite, diatomite, delaminated kaolinite, diatomaceous earth, sepiolite, attapulgite or mixtures thereof. In some embodiments, the pore regulating agent is combustible and removed by calcination. In some embodiments, the pore regulating agent is water soluble. According to some embodiments, the porous shaped bodies have a median pore size in the range of from about 50 to about 5,000 angstrom.

In some embodiments of the instant invention, the method further comprises leaching the porous shaped bodies. The step of leaching may include treating the porous shaped bodies with an acid to remove at least part of the alumina content or treating the porous shaped bodies with a base to remove at least part of the silica content. Yet in other embodiments, the step of leaching may include treating the porous shaped bodies with an acid to remove at least part of the alumina content and with a base to remove at least part of the silica content. In some embodiments, the leaching of step is followed by a filtering and washing step. In other embodiments, the step of leaching is prior to the step of removing the pore regulating agent or after the step of removing the pore regulating agent.

In some embodiments, the clay is an aluminosilicate material such as kaolin clay, calcined clay, hydrated clay, delaminated clay, dealuminated clay, desilicated clay or mixtures thereof. In other embodiments, the aluminosilicate clay material is subjected to acid leaching to remove part of the alumina.

In some embodiments, the step of shaping comprises spray drying, extrusion, pelletizing or sphereizing or combinations thereof.

In some embodiments, the calcination step is carried out at a temperature from about 200° C. to about 1,200° C., or at 1,000° C. for a time from about 0.1 hour to about 100 hours.

In some embodiments, the aqueous reaction mixture comprises aluminosillicate and zeolite directing seeds and the step of thermally treating the aqueous reaction mixture is carried out at a temperature from about 80° C. to about 250° C. for a time from about 0.5 hours to about 50 hours.

In some embodiments, the seeding material is an organic seed material, an inorganic seed material, a MFI seed material or a combination thereof

In some embodiments, the zeolite is a MFI-type zeolite. In some embodiments, the zeolite is selected form the group consisting of ZSM zeolite, beta zeolite and mixtures thereof.

According to some embodiments, the binder material is a silicate, a phosphate, an alumina, a silica-alumina or mixtures thereof.

In further embodiments, the method comprises ion-exchanging the shaped bodies to replace sodium ions with ammonium ions, alkaline earth metals, transition metals, noble metals or rare earth metals. In some embodiments, ions in the shaped bodies are exchanged with metal ions selected from the group of K, Ca, Mg, Ba, Zn, Mn, Cu, Ni, Fe, Mo, La, Ce or mixtures thereof. In other embodiments, the ion-exchanged shaped bodies are subjected to calcination.

Aspects of the invention relate to the catalytic thermolysis of cellulosic biomass, the process comprising heating the cellulosic biomass to a conversion temperature in presence of the catalyst system comprising in-situ grown MFI-type zeolite into clay matrixes exhibiting hierarchical pore structures.

Other aspects of the invention relate to a composition for the conversion of biomass comprising a catalyst system comprising in situ grown zeolites into an aluminosilicate clay matrix having a hierarchical pore structure ranging from about 50 to about 5,000 angstrom and a feedstock having a carbon ¹⁴C isotope content of about 107 pMC. In some embodiments, the zeolite is a MFI-type zeolite. In some embodiments, the clay is kaolin clay. In some embodiments, the feedstock is a particulated biomass, or is a product derived from pyrolysis of biomass such as oil vapor or a bio-oil.

### BRIEF DESCRIPTION OF THE DRAWINGS

FIG. 1 represents a non limiting comparison of the characterization by X-ray Diffraction (XRD) of the microspheres of one embodiment and a computer simulated MFI.

### DETAILED DESCRIPTION OF THE INVENTION

Aspects of the invention relate to catalyst compositions comprising zeolites in-situ grown into clay matrixes exhibiting hierarchical pore structures for use in the catalytic thermoconversion of solid biomass material into liquid fuels or specialty chemicals. In some aspects, the invention relates to catalyst compositions comprising “in-situ” grown pentasil type zeolites on clay-based matrix having “custom-made” or engineered hierarchical pore structures that allow the zeolitic phase to form on large pores and surface areas. Such compositions allow for the reactant oil-feed molecules to come directly in contact with the catalytically active sites located in the zeolitic phase, without being retarded by matrix diffusion limitations.

It should be noted, that catalyst compositions, besides being exposed to continuous and/or repeated impact with metallic surfaces when introduced and moved through the thermoconversion reactor, can be additionally exposed to impact upon collision with the solid biomass feed particles. When biomass feed particles contain inorganic matter, for example clays, sand, etc., the collision of the catalyst with such biomass particles may cause further attrition to the catalyst particle mass.

The attrited material produced by the fracture and/or by the surface grinding of the catalyst particle may include smaller fragmented particles and microfines, having sizes down to submicron and to the colloidal ranges.

The submicron attrited particles may react with the nascent formed bioacids in the hot reactor environment, to form other organometallic colloidal complexes. In some cases, such very fine dispersions of submicron colloidal formed materials may end up being dispersed in the oil phase product coming out from the thermoconversion process. Although it may be difficult and costly to remove these mixtures of fine particles and colloidal phases from the bio-oil, it is generally necessary to remove these mixtures from the bio-oil to obtain a substantially clean bio-oil to be used as a feed to the hydroprocessing reactors containing the hydrotreating catalyst. Removal of mixtures of fine particles and colloidal phases from the bio-oil can avoid catalyst deactivation, flow plugging and/or back pressure increase.

In some embodiments, in order to facilitate the overall upgrading process of the crude bio-oil, including filtrations, water phase separation and in order to protect the catalyst during the hydrotreating steps, catalysts for the thermoconversion should exhibit suitable attrition resistance to the overall exposure the catalyst experiences. In some embodiments, the catalyst compositions may exhibit high attrition resistance to the mechanical exposure with the metal surfaces of the reactor including valves, feeders, cyclones, and the like, with the biomass and with metallic contaminants associated with the biomass. In some embodiments, the catalyst compositions can exhibit high attrition resistance to chemical exposure such as the hot acidic compounds generated by the thermoconversion of biomass in the reactor.

In some embodiments, the catalyst compositions comprise microspherical particles having in-situ grown zeolites. In some embodiments, the catalyst compositions may be produced by forming zeolite in situ in a matrix phase, such as clay. The zeolitic and matrix phases can be modified to exhibit suitable attrition resistance and/or be more effective in the catalytic thermoconversion of biomass to bio-oils and hence in reducing the coke formation and/or catalyst deactivation rates.

Growing zeolites “in-situ” on pre-formed clay-based microspheres can provide fundamental advantages as compared to including the pre-crystallized zeolite particles into a slurry comprising the matrix components and a binder, which is subsequently spray dried to form microspheres containing embedded zeolitic phase. In situ grown catalysts may exhibit a higher attrition resistance when compared to catalysts comprising the same zeolite components but formed into microspheres with different binders and different compounding processes. Other advantages of the such “in-situ” growth process include the cost effective formation of microsphere particles that are attrition resistant, have a high concentration of zeolite, and a considerable number of zeolite crystallites grown on the surface of the microsphere, allowing direct access for the reactant oil-feed to the catalytic active sites, with minimum diffusional restrictions.

In some aspects, the invention relates to catalyst compositions and methods of making catalyst compositions comprising “in-situ” grown pentasil type zeolites on a clay-based matrix that has custom-made or engineered hierarchical pore structures allowing for the zeolitic phase to grow on large pores and surface areas. The resulting catalyst compositions allow for the reactant oil-feed molecules to come directly in contact with the catalytically active sites located in the zeolitic phase, without being retarded by matrix diffusion limitations.

In some embodiments, the methods for making catalyst compositions comprises the steps of (a) forming a clay-based microsphere or other kinds of shaped bodies, with “designed” meso and macro hierarchical pore structure; and, (b) “in-situ” forming pentasil-type zeolites on the clay-based microspheres exhibiting the formed meso/macro hierarchical pore structure. In some embodiments, the pore structure comprises pore sizes ranging from about 20 to about 5,000 angstrom, from about 50 to about 5,000 angstrom, from about 100 to about 5,000 angstrom, from about 200 to about 2,000 angstrom, from about 100 to about 2,000 angstrom, or from about 500 to about 5,000 angstrom.

Aspects of the invention provide methods to form microsphere particles that have larger pore and channels throughout the catalyst particle. Such large interconnecting pathways within the matrix and microsphere particles allow the zeolite crystals to be homogeneously suspended, dispersed, and be sufficiently accessible to the reactant oil-feed molecules.

In some embodiments, the catalyst microsphere bulk porosity can be optimized against its required physical strength and attrition resistance when used in the fluidized bed reactor with very short residence times.

In some embodiments, the method for making catalyst compositions comprises forming a slurry containing a clay and binder components, and incorporating in the slurry an organic material or pore regulating agent, in a fine particular size form. In some embodiments, the organic material can be combustible when calcined in air, so that when the organic material escapes from the catalyst microsphere in a gaseous form, it leaves behind extra bulk porosity and pathways. The calcination can be carried out at a temperature from about 200° C. to about 1000° C. for a time from about 0.1 hour to about 100 hours. In some embodiments, the calcination step is carried out at a temperature from about 550° C. to about 650° C. In some embodiments, the calcination step is carried out at about 600° C.

In some embodiments, low cost materials derived from agricultural products can be used as pore regulating agents. These materials have the advantage not to be hazardous to human health and to be produced at relative low cost compared to known pore regulating agents such as carbon black and soluble organic polymers. These materials include, but are not limited to, cellulosic types, starches, sawdust, corn flowers, wood flowers, shortgum, gums, and the like.

In some embodiments, combustible organic materials includes waste plastics, for example, selected and collected from the municipal solid waste. Such materials can be crushed to small size chips, ground and pulverized in high energy mills to produce fine powders having particles sizes in the micron and submicron ranges. According to other embodiments, fine powders can be produced using vortex cyclonic jet mills, as described in U.S. Pat. No. 6,971,594 incorporated herein by reference in its entirety.

In some embodiments, materials with ligno-cellulosic compositions such as woody materials from forestry or agricultural cellulose products such as corn stover, sugar bagasse, and the like, can be processed similarly to fine powders with defined particle sizes in the micron and submicron ranges. In some embodiments, the organic materials include saw dust produced in wood mills.

In some embodiments, catalyst compositions having a hierarchical meso/macro porous structure can be formed using a clay or portion of the clay that has a different particle morphology than the hydrous kaolin clay, such as, for example, delaminated kaolin, halloysite, diatomaceous earth, sepiolite, attapulgite or combinations thereof.

In some embodiments, the clay can be first treated with an acid or base to leach out some of the lattice metals. In some embodiments, delaminated clay, such as delaminated kaolin, may optionally be calcined. The delaminated clay can be treated with an acid to remove a portion of the clay-lattice alumina, or with an alkaline to remove a portion of the clay-lattice silica.

In some embodiments, clays with different particle morphologies can be used in combination with dealuminated or desilicated clays.

In some embodiments, combinations of alumino-silicate, alumina, silica that have been calcined to form transition phases, for example spinels or mixed-metal-oxides phases can be used.

In some embodiments, the clay material can be used in combination with a pore regulating agent, such as a combustible material. The combustible material can comprise a plastic, resin, rubber, carbohydrates, organic polymers or combinations thereof.

In some embodiments, the microspheres or shaped bodies containing pore regulating agent (PRA) can be acid leached. The acid leaching of the shaped bodies containing the pore regulating agent can be done after a calcination step, that may remove (e.g. by burning off) the pore regulating agent. Leaching the shaped bodies after the calcination step can have the advantage to form physically stronger shaped bodies that can retain their shape and strength during the acid leaching process. Alternatively, the calcined clay (e.g. calcined kaolin clay) can be acid leached before it is formed into shaped bodies. In some embodiments, the calcined shaped bodies can be base-leached to remove part of the silica from the clay and increase its porosity. The base-leached can be used for the formation of the catalyst composition with proper adjustments of the silica content and seed addition as described below.

In some embodiments, the methods of making the catalyst compositions comprises forming clay-based microspheres comprising a carbohydrate combustible pore regulating material such as, for example, wood flour, and calcining microspheres. The calcined microsphere can subsequently be acid leached to remove a portion of the alumina content of the clay phase and mixed with the appropriate chemicals and zeolite seeds to form a slurry. In some embodiments, the slurry comprising the zeolite seeds can be thermally treated to form crystallize zeolites on the macroporous microspheres. In other embodiments, the zeolite is a mordenite framework inverted-type zeolite (MFI-type zeolite). In yet other embodiments, the step of thermally treating is carried out at a temperature from about 80° C. to about 250° C. for a time from about 0.5 hours to about 50 hours.

In some embodiments, in-situ formed MFI-type zeolite on the macroporous microspheres can be subjected to ion-exchange with cations such as ammonium, protons, alkaline and alkaline earth, transition and rare earth metals, as well as noble metals and compound bearing phosphorous.

In some embodiments, solid particulate biomass can be first subjected to thermal pyrolysis in presence of a heat carrier within a first reactor or within a first lower stage of a reactor, to form primary reaction products such as vapor oil or bio-oil. In some embodiments, the primary reaction products can be mixed with the catalysts compositions and catalytically converted under appropriate conditions within a second reactor or within a second upper stage of a reactor. Such process are disclosed in U.S. patent application Ser. No. 12/947,449 which is incorporated herein by reference in its entirety.

One skilled in the art will appreciate that biomass or products derived from pyrolysis of the biomass, such as oil/vapor products, can be distinguished from products containing fossil carbon by the carbon ¹⁴C isotope content (also referred herein as radiocarbon).

Carbon ¹⁴C isotope is unstable, having a half life of 5730 years and the relative abundance of carbon ¹⁴C isotope relative to the stable carbon ¹³C isotope can enable distinction between fossil and biomass feedstocks. In some embodiments, the presence of ¹⁴C isotope can be considered as an indication that the feedstocks or products from pyrolysis include renewable carbon rather than fossil fuel-based or petroleum-based carbon. Carbon ¹⁴C isotope of the total carbon content of renewable feedstock or products derived from renewable feedstock is typically 100% whereas the carbon ¹⁴C isotope of the total carbon content of petroleum-based compounds is typically 0%.

Assessment of the renewably based carbon content of a material can be performed through standard test methods, e.g. using radiocarbon and isotope ratio mass spectrometry analysis. ASTM International (formally known as the American Society for Testing and Materials) has established a standard method for assessing the biobased or renewable carbon content of materials. The application of the ASTM-D6866 can be used to derive biobased or renewable carbon content. The analysis can be performed by deriving a ratio of the amount of carbon ¹⁴C in an unknown sample compared to that of a modern reference standard. This ratio is reported as percent modern carbon or pMC. The distribution of carbon ¹⁴C isotope within the atmosphere has been approximated since its appearance, showing values that are greater than 100 pMC for plants and animals living since AD 1950. The distribution of carbon ¹⁴C isotope has gradually decreased over time with values of about 107.5 pMC. In some embodiments, biomass or compounds derived from biomass have a carbon ¹⁴C signature of about 107.5 pMC.

### EXAMPLES

### Example 1

An aqueous slurry is prepared by dispersing hydrated kaolin in a sodium silicate solution at 45% solids using high shear mixing. The resulting slurry (90% kaolin and 10% silica) is spray dried to form microspheres having an average particle size of 75 microns.

The resulting kaolin microspheres are calcined at 980° C. for two hours to form calcined microspheres. The calcined microspheres are then mixed together with sodium silicate, water and zeolite-directing seeds at a weight ratio of calcined microspheres to seeds to silica (supplied by sodium silicate) of 90:2:100. The pH of the resulting mixture is adjusted to 11.5 with phosphoric acid solution.

This mixture is heated in an autoclave with agitation at 170° C. for 24 hours. The microspheres are then separated from the mother liquor by filtration and then washed with water and finally dried at 120° C. The sample is characterized by X-ray Diffraction (XRD) to confirm that the resulting microspheres contain ZSM-5.

### Example 2

An aqueous slurry is prepared by dispersing delaminated kaolin in a sodium silicate solution at 45% solids using high shear mixing. The resulting slurry (90% delaminated kaolin and 10% silica) is spray dried to form microspheres having an average particle size of 75 microns.

The resulting microspheres are calcined at 980° C. for two hours to form calcined microspheres. The calcined microspheres are then mixed together with sodium silicate, water and zeolite-directing seeds at a weight ratio of calcined microspheres to seeds to silica (supplied by sodium silicate) of 90:2:100. The pH of the resulting mixture is adjusted to 11.5 with phosphoric acid solution.

This mixture is heated in an autoclave with agitation at 170° C. for 24 hours. The microspheres are then separated from the mother liquor by filtration and then washed with water and finally dried at 120° C. The sample is characterized by X-ray Diffraction (XRD) to confirm that the resulting microspheres contain ZSM-5.

### Example 3

The calcined microspheres are produced as described in the second example and are acid leached with nitric acid, then filtered, washed, dried and calcined at 400° C. The resulting microspheres are mixed together with sodium silicate, water and zeolite-directing seeds, and then treated with phosphoric acid as described above.

This mixture is heated in an autoclave with agitation at 170° C. for 24 hours. After reaction, the microspheres are separated from the mother liquor by filtration and then washed with water and finally dried at 120° C. The sample is characterized by X-ray Diffraction (XRD) to confirm that the resulting microspheres contain ZSM-5.

### Example 4

An aqueous slurry is prepared by dispersing metakaolin in a sodium silicate solution at 45% solids using high shear mixing. The resulting slurry (90% metakaolin and 10% silica) is spray dried to form microspheres having an average particle size of 75 microns.

The resulting microspheres are calcined at 980° C. for two hours to form calcined microspheres. The calcined microspheres are then mixed together with sodium silicate, water and zeolite-directing seeds at a weight ratio of calcined microspheres to seeds to silica (supplied by sodium silicate) of 90:2:100. The pH of the resulting mixture was adjusted to 11.5 with phosphoric acid solution.

This mixture is heated in an autoclave with agitation at 170° C. for 24 hours. The microspheres are then separated from the mother liquor by filtration and then washed with water and finally dried at 120° C. The sample is characterized by X-ray Diffraction (XRD) to confirm that the resulting microspheres contain ZSM-5.

### Example 5

The calcined microspheres are produced as described in Example 1, and are leached with sodium hydroxide solution at 95° C. for two hours, then filtered, washed and dried.

The resulting caustic treated microspheres are mixed together with sodium silicate, water and zeolite-directing seeds as described in Example 1, and then heated in an autoclave with agitation at 170° C. for 24 hours. After reaction, the microspheres are separated from the mother liquor by filtration, then washed with water and finally dried at 120° C. The sample is characterized by X-ray Diffraction (XRD) to confirm that the resulting microspheres contain ZSM-5.

### Example 6

An aqueous slurry is prepared by dispersing hydrated kaolin in a sodium silicate solution at 45% solids using high shear mixing. Corn starch (10%) is added to the hydrated kaolin-sodium silicate mixture. The resulting slurry is spray dried and calcined at 980° C. for two hours to form calcined microspheres. Upon calcination, the corn starch burns out producing microspheres with enhanced macroporosity. The resulting microspheres are then mixed together with sodium silicate, water and zeolite-directing seeds at a weight ratio of calcined microspheres to seeds to silica (supplied by sodium silicate) of 90:2:100. The pH of the resulting mixture is adjusted to 11.5 with phosphoric acid solution.

This mixture is heated in an autoclave with agitation at 170° C. for 24 hours. The microspheres are then separated from the mother liquor by filtration and then washed with water and finally dried at 120° C. The sample is characterized by X-ray Diffraction (XRD) to confirm that the resulting microspheres contain ZSM-5.

### Example 7

An aqueous slurry is prepared by dispersing hydrated kaolin in a sodium silicate solution at 45% solids using high shear mixing. Wood flour (10%) is added to the hydrated kaolin-sodium silicate mixture. The resulting slurry is spray dried and calcined at 980° C. for two hours to form calcined microspheres. Upon calcination, the wood flour burns out producing microspheres with enhanced macroporosity. The resulting microspheres are then mixed together with sodium silicate, water and zeolite-directing seeds at a weight ratio of calcined microspheres to seeds to silica (supplied by sodium silicate) of 90:2:100. The pH of the resulting mixture is adjusted to 11.5 with phosphoric acid solution.

This mixture is heated in an autoclave with agitation at 170° C. for 24 hours. The microspheres are then separated from the mother liquor by filtration and then washed with water and finally dried at 120° C. The sample is characterized by X-ray Diffraction (XRD) to confirm that the resulting microspheres contain ZSM-5.

### Example 8

An aqueous slurry is prepared by dispersing delaminated kaolin in a sodium silicate solution at 45% solids using high shear mixing. Corn starch (10%) is added to the delaminated kaolin-sodium silicate mixture. The resulting slurry is spray dried and calcined at 980° C. for two hours to form calcined microspheres. Upon calcination, the corn starch burns out producing microspheres with enhanced macroporosity. The resulting microspheres are then mixed together with sodium silicate, water and zeolite-directing seeds at a weight ratio of calcined microspheres to seeds to silica (supplied by sodium silicate) of 90:2:100. The pH of the resulting mixture is adjusted to 11.5 with phosphoric acid solution.

This mixture is heated in an autoclave with agitation at 170° C. for 24 hours. The microspheres are then separated from the mother liquor by filtration and then washed with water and finally dried at 120° C. The sample is characterized by X-ray Diffraction (XRD) to confirm that the resulting microspheres contain ZSM-5.

### Example 9

An aqueous slurry is prepared by dispersing hydrated kaolin in a sodium silicate solution at 45% solids using high shear mixing. Corn starch (10%) is added to the hydrated kaolin-sodium silicate mixture. The resulting slurry is spray dried and calcined at 980° C. for two hours to form calcined microspheres. Upon calcination, the corn starch burns out producing microspheres with enhanced macroporosity. The resulting microspheres are then acid leached with nitric acid. The leached microspheres are then mixed together with sodium silicate, water and zeolite-directing seeds as described in Example 1 and heated in an autoclave with agitation at 170° C. for 24 hours. After reaction, the microspheres are separated from the mother liquor by filtration, then washed with water and finally dried at 120° C. The sample is characterized by X-ray Diffraction (XRD) to confirm that the resulting microspheres contain ZSM-5.

### Example 10

An aqueous slurry is prepared by dispersing hydrated kaolin in a sodium silicate solution at 45% solids using high shear mixing. Corn starch (10%) is added to the hydrated kaolin-sodium silicate mixture. The resulting slurry is spray dried and calcined at 980° C. for two hours to form calcined microspheres. Upon calcination, the corn starch burns out producing microspheres with enhanced macroporosity. The resulting microspheres are then base leached with sodium hydroxide as described in Example 5. The leached microspheres are then mixed together with sodium silicate, water and zeolite-directing seeds as described in Example 1 and heated in an autoclave with agitation at 170° C. for 24 hours. After reaction, the microspheres are separated from the mother liquor by filtration, then washed with water and finally dried at 120° C. The sample is characterized by X-ray Diffraction (XRD) to confirm that the resulting microspheres contain ZSM-5.

### Example 11

An aqueous slurry was prepared by dispersing hydrated kaolin in water at 30% solids. The resulting slurry was spray dried to microspheres having an average size of 75 microns.

The resulting kaolin microspheres were calcined at 980° C. for two hours to form calcined microspheres. The calcined microspheres were then mixed together with sodium silicate, water and a zeolite-directing seed solution in the amounts shown in Table 1 to form zeolite particles with alumina microsphere cores.

TABLE 1

| Seed Solution | Weight | | Weight |
|---|---|---|---|
| Preparation | (g) | Zeolite Preparation | (g) |
| Water | 15.14 | Water | 1,188.31 |
| Sodium Hydroxide | 177.9 | Calcined Kaolin | 89.17 |
| | | Microspheres | |
| Sodium Aluminate | 20.39 | Seed Solution | 63.61 |
| Water Glass | 186.51 | Water Glass | 239.49 |
| Age at 38° C. 24 Hours | | Adjust pH to 11.5 | 19.71 |
| Quench at Room | | with 57% H₃PO₄ | |
| Temperature | | Autoclave at 170° | |
| | | C. for 24 Hours | |
| Sodium Hydroxide | 59.12 | | |
| Water Glass (Dilution) | 136.75 | | |
| Total | 536.75 | Total | 1,600 |

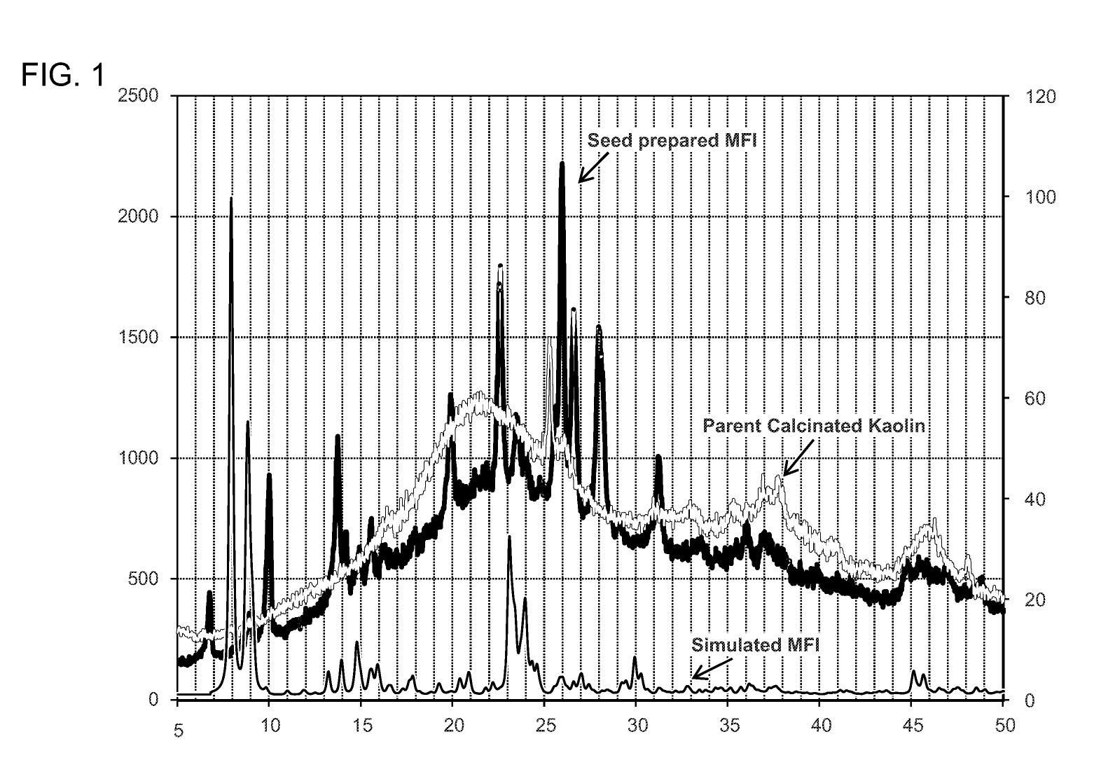

The microspheres were then separated from the mother liquor by filtration and dried at 120° C. The sample was characterized by X-ray Diffraction (XRD) using a Rigaku MiniFlexII X-ray diffractometer with Cu (K_{α}) radiation to confirm that the microspheres contained reflections corresponding to the MFI structure. The XRD of the microspheres and a computer simulated MFI are compared in FIG. 1. The sample contained 63.25% SiO₂ and 28.72% Al₂O₃ as determined by X-ray fluorescence (XRF) using a Panalytical AN O3 1KW instrument. The surface area as measured on a Micromertics ASAP 2420 by the BET method was 13.43 m²/gm. The meso surface area was 9.66 m²/gm. The particle size distribution (PSD) was obtained by laser interferometry using a Malvern Hydro 2000G and had an average particle size of 106 microns.

Admixtures of zeolite ammonium ZSM-5 (CBV3024E, available from Zeolyst International) and calcined microspheres at 10%, 20%, 30%, 40%, and 50% zeolite/kaolin microspheres were prepared and the XRD patterns determined. The peak heights are given in Table 2. The catalyst prepared as in Table 1 is Entry 7 in Table 2.

The catalyst was tested in a small scale fluid bed reactor using standard test conditions for biomass conversion activity and compared to a standard catalyst containing 40% HZSM-5 used for biomass conversion activity has an average PSD of 75 microns and the following physical properties.

TABLE 2

| Surface Area | Meso Porosity | Alumina | Silica |
|---|---|---|---|
| m²/gm | Area m²/gm | Wt. % | wt. % |
| 121.20 | 20.44 | 16.29 | 77.85 |

The standard catalyst containing 40% HZSM-5 zeolite gave a yield of 27% oil with an oxygen in oil content of 19%. The MFI phase catalyst as prepared in Table 1 gave an oil yield of 24% with an oxygen in oil content of 24%.

TABLE 3

| % Zeolite | Peak Height |
|---|---|
| 10 | 2325 |
| 20 | 2368 |
| 30 | 3433 |
| 40 | 4318 |
| 50 | 3837 |
| 100 | 11341 |
| 15.9 | 1758 |

The physical property data and activity testing of the MFI phase catalyst as prepared in Table 1 compares well with the standard catalyst containing 40% HZSM-5 zeolite demonstrating that an effective catalyst may be prepared using the foregoing methodology.

The present invention provides among other things catalysts systems, process of making the catalyst systems and methods for converting biomass into fuel and chemicals. While specific embodiments of the subject invention have been discussed, the above specification is illustrative and not restrictive. Many variations of the invention will be come apparent to those skilled in the art upon review of this specification. The full scope of the invention should be determined by reference to the claims, along with their full scope of equivalents, and the specification, along with such variations.

### INCORPORATION BY REFERENCE

Reference is made to U.S. Provisional Patent Application Ser. No. 61/600,153, entitled “CATALYST COMPOSITION WITH INCREASED BULK ACTIVE SITE ACCESSIBILITY FOR THE CATALYTIC THERMOCONVERSION OF BIOMASS TO LIQUID FUELS AND CHEMICALS”, Attorney Docket No. ID 260US-PRO, filed on Feb. 17, 2012 and to U.S. Provisional Patent Application Ser. No. 61/600,160, entitled “CATALYST COMPOSITION COMPRISING MATRIXES AND ZEOLITES WITH HIERARCHICAL PORE STRUCTURES FOR OPTIMUM ACTIVE SITE ACCESSIBILITY FOR USE IN THE CATALYTIC THERMOCONVERSION OF BIOMASS TO LIQUID FUELS AND CHEMICALS”, Attorney Docket No. ID 261US-PRO, filed on Feb. 17, 2012, the entire content of each being hereby incorporated by reference in its entirety. All publications, patents and mentioned herein are hereby incorporated by reference in their entirety as if each individual publication or patent was specifically and individually indicated to be incorporated by reference.

1. A method of making a biomass catalytic cracking catalyst system, the method comprising the steps of:
a. preparing a slurry precursor mixture by mixing an aluminosilicate clay material with a pore regulating agent and optionally a binder;
b. shaping the mixture into shaped bodies;
c. removing the pore regulating agent to form porous shaped bodies;
d. preparing an aqueous reaction mixture comprising the porous shaped bodies in presence of a seeding material;
e. thermally treating the aqueous reaction mixture to form the catalyst system; and
f. contacting the catalyst system with biomass particles.

2. The method of claim 1 wherein the pore regulating agent is removed by calcination.

3. The method of claim 1 further comprising calcining the catalyst system before the contacting step.

4. The method of claim 1 further comprising contacting the catalyst system with biomass-derived oils.

5. The method of claim 1 further comprising contacting the catalyst system with bio-oil or bio-oil vapors.

6. The method of claim 1 further comprising leaching the porous shaped bodies.

7. The method of claim 6 wherein the step of leaching includes treating the porous shaped bodies with an acid to remove at least part of the alumina content.

8. The method of claim 6 wherein the step of leaching includes treating the porous shaped bodies with a base to remove at least part of the silica content.

9. The method of claim 6 wherein the step of leaching includes treating the porous shaped bodies with an acid to remove at least part of the alumina content and with a base to remove at least part of the silica content.

10. The method of claim 1 wherein the mixture of step (a) is a homogeneous mixture.

11. The method of claim 1 wherein the porous shaped bodies have a median pore size in the range of from about 50 to about 5,000 angstrom.

12. The method of claim 1 wherein the step of shaping comprises spray drying, extrusion, pelletizing, sphereizing, or combinations thereof.

13. The method of claim 1 wherein the pore regulating agent is an organic material selected from the group consisting of compounds containing cellulosic type, starch, sawdust, corn flour, wood flour, shortgum, gums, corn stover, sugar bagasse, plastic, resin, rubber, carbohydrates, organic polymers, and mixtures thereof.

14. The method of claim 1 wherein the pore regulating agent is an inorganic material selected from the group of saponite, halloysite, diatomite, delaminated kaolinite, diatomaceous earth, sepiolite, attapulgite or mixtures thereof.

15. The method of claim 1 wherein the pore regulating agent is combustible.

16. The method of claim 1 wherein the pore regulating agent is water soluble.

17. The method of claim 3 wherein the calcination step is carried out at a temperature from about 200° C. to about 1,200° C. for a time from about 0.1 hour to about 100 hours.

18. The method of claim 3 wherein the calcination step is carried out at about 1,000° C.

19. The method of claim 1 wherein the aluminosilicate clay material is subjected to acid leaching to remove part of the alumina.

20. The method of claim 1 wherein the aluminosilicate clay material is a kaolin clay.

21. The method of claim 1 wherein step (e) is carried out at a temperature from about 80° C. to about 250° C. for a time from about 0.5 hours to about 50 hours.

22. The method of claim 1 wherein the catalyst system comprises the aluminosillicate and a zeolite.

23. The method of claim 1 wherein the seeding material is an organic seed material, an inorganic seed material, a MFI seed material or combinations thereof

24. The method of claim 22 wherein the zeolite is a MFI-type zeolite.

25. The method of claim 22 wherein the zeolite is selected form the group consisting of ZSM zeolite, beta zeolite and mixtures thereof.

26. The method of claim 1 wherein the binder material is a silicate, a phosphate, an alumina, a silica-alumina or mixtures thereof.

27. The method of claim 6 wherein the leaching of step is followed by a filtering and washing step.

28. The method of claim 1 wherein step (d) is in presence of sodium silicate, alumina, or combinations thereof.

29. The method of claim 1 wherein the aluminosilicate clay material comprises calcined clay, hydrated clay, delaminated clay, dealuminated clay, desilicated clay or a combination thereof.

30. The method of claim 1 further comprising ion-exchanging the shaped bodies to replace sodium ions with ammonium ions, alkaline earth metals, transition metals, noble metals or rare earth metals.

31. The method of claim 30 wherein ions in the shaped bodies are exchanged with metal ions selected from the group of K, Ca, Mg, Ba, Zn, Mn, Cu, Ni, Fe, Mo, La, Ce or mixtures thereof.

32. The method of claim 30 further comprising subjecting the ion-exchanged shaped bodies to calcination.

33. The method of claim 6 wherein the step of leaching is prior to the step of removing the pore regulating agent or after the step of removing the pore regulating agent.

34. A method of making a biomass catalytic cracking catalyst system, the method comprising the steps of:
a. preparing a slurry precursor mixture by mixing an aluminosilicate clay material with a binder material and a pore regulating agent;
b. shaping the mixture into shaped bodies;
c. removing the pore regulating agent to form porous shaped bodies;
d. leaching the porous shaped bodies to form modified shaped bodies;
e. preparing an aqueous reaction mixture comprising the modified shaped bodies in presence of a seeding material; and
f. thermally treating the aqueous reaction mixture to form the catalyst system.

35. The method of claim 34 further comprising mixing the catalytic cracking catalyst system with biomass particles.

36. The method of claim 34 further comprising mixing the catalytic cracking catalyst system with biomass derived vapors.

37. The method of claim 34 further comprising mixing the catalytic cracking catalyst system with bio-oil or bio-oil vapors.

38. The method of claim 34 wherein the catalyst system comprises MFI-type zeolite.

39. A process for catalytic thermolysis of cellulosic biomass, the process comprising heating the cellulosic biomass to a conversion temperature in presence of the catalyst system prepared according to the process of claim 1.

40. The process of claim 39 wherein the catalyst system comprises a MFI-type zeolite.

41. A composition for the conversion of biomass comprising:
a. a catalyst system comprising in situ grown zeolites into a aluminosilicate clay matrix having a hierarchical pore structure ranging from about 50 to about 5,000 angstrom; and
b. a feedstock having a carbon ¹⁴C isotope content of about 107 pMC.

42. The composition of claim 41 wherein the zeolite is a MFI-type zeolite.

43. The composition of claim 41 wherein the clay is kaolin clay.

44. The composition of claim 41 wherein the feedstock is a particulated biomass, or is a product derived from pyrolysis of biomass.

45. The composition of claim 41 wherein the feedstock is a bio-oil vapor or a bio-oil.
